(19) United States
(12) Patent Application Publication
(10) Pub. No.: US 2004/0173535 A1
(43) Pub. Date: Sep. 9, 2004

(54) Serviceable electrodeionization apparatus and method for resin refill

(75) Inventor: Xiang Li, Huzhou Zhejiang Province (CN)

Correspondence Address: CAESAR, RIVISE, BERNSTEIN,, COHEN & POKOTILOW, LTD., 11TH FLOOR, SEVEN PENN CENTER, PHILADELPHIA, PA, 19103-2212, US

(73) Assignee: ZHEJIANG OMEX ENVIRONMENTAL ENGINEERING, LTD., Zhejiang (CN)

(21) Appl. No.: 10/774,257

(22) Filed: Feb. 6, 2004

Related U.S. Application Data
(60) Provisional application No. 60/445,490, filed on Feb. 6, 2003.

(51) Int. Cl. B01D 15/00

(52) U.S. Cl. 210/660

(57) ABSTRACT

A replaceable spiral wound membrane element can be inserted and removed from its housing or pressure vessel in one piece for servicing or replacement. The replaceable wound membrane element preferably includes a concentrate pipe connected to spacers and membranes that are wound around the concentrate pipe to form a spiral membrane element. After the replaceable membrane element is placed inside its housing, its dilute spacers are filled with ion exchange resin and the housing is sealed to form an electrodeionization (EDI) module.

### FIELD OF INVENTION

This invention relates to a serviceable electrodeionization water producing apparatus adapted to transfer ions in a liquid under the influence of an electrical field, and more particularly, to a helical electrodeionization apparatus that can be easily and efficiently serviced.

### BACKGROUND OF THE INVENTION

Previously, various techniques have been developed to purify and isolate liquids or to obtain concentrated pools of specific ions or molecules from a liquid mixture, such as electrodialysis, liquid chromatography, membrane filtration, ion exchange, etc. Electrodeionization (EDI) is a technique that removes ionizable species from liquids using electrically active media in an electrical potential to influence ion transport. The electrically active media may alternatively collect and discharge ionizable species, or facilitate the transport of ions continuously by ionic or electronic substitution mechanisms.

The first apparatus and method known for treating liquids by electrodeionization was described by Kollsman in U.S. Pat. Nos. 2,689,826 and 2,815,320. Improved electrodeionization systems have been shown in U.S. Pat. Nos. 4,925,541; 4,931,160 and 5,316,637. The typical structure of a module used for electrodeionization includes alternating electroactive semi-permeable anion and cation ion exchange membranes in a stack mechanical sheet type structure.

An electrodeionization apparatus having a helical configuration is shown by inventor Xiang Li in U.S. Pat. No. 6,190,528 (the '528 patent), the contents of which are incorporated herein by reference in their entirety. In the '528 patent, an insulated net-separating wall is positioned between a pair of anion and cation exchange membranes to form a special membrane bag type flow unit I. Each flow unit I is linked with at least one slot on a side wall of a central pipe, and is rolled to form a spiral wounded cylinder structure which centers on the central pipe. A conductive crust is formed by winding metal outside the cylinder and electrically active media (e.g., ion exchange resin) is inserted into the regions between the membrane bags to form a flow unit II. The product is enclosed by a housing with dome shaped covers.

Previously, electrodeionization modules, including the membrane resin conductive elements and housing, were assembled at a central plant and the membranes and resin installed. Typically, the entire module was replaced when service became necessary as the pipe and flow units could not be easily separated from the housing and covers. This service is expensive and generally requires that the entire module be removed from the field for replacement. Accordingly, it is desirable to provide a low cost, easy to service electrodeionization device.

### SUMMARY OF THE INVENTION

The present invention is directed to an apparatus and technique for replacing resin in an EDI module. In a preferred embodiment, the apparatus includes a central pipe preferably made of, but not limited to, stainless steel. Attached to the central pipe are layers of membrane and spacers preferably arranged as groups, for example, in order of a concentrate spacer, an anion membrane, a dilute spacer, and a cation membrane. At least one of the groups of layers is used and attached to the central (or concentrate) pipe. After attachment to the central pipe, the layers are wound around the pipe. Glue or other adhesives are added to seal the membranes, spacers, and pipe together to form a replaceable spiral wound membrane element in a generally cylindrical shape.

This element is inserted into a housing. While not being limited to a particular theory, the housing is preferably a fiberglass round pressure vessel about and enclosing a titanium shroud. The titanium shroud is a preferred type of electrode, but it is understood that steel or other conductive material can be used as the electrode wound within the housing.

The method of resin filling includes the steps of connecting a water supply to purified water, connecting an air supply to oil-free air, and alternately filling the dilute chamber or spacer with cation resin and anion resin.

Further scope of applicability of the present invention will become apparent in the description given hereinafter. However, it should be understood that the detailed description and specific examples, while indicating preferred embodiments of the invention, are given by way of illustration only, since the invention will become apparent to those skilled in the art from this detailed description.

### BRIEF DESCRIPTION OF THE DRAWINGS

The invention will be described in conjunction with the following drawings, in which like-referenced numerals designate like elements, and wherein:

FIG. 1 is a view of a replaceable membrane element in accordance with a preferred embodiment of the invention;

FIG. 2 is a top sectional view of a spiral would EDI module including the replaceable membrane element shown in FIG. 1;

FIG. 3 is a schematic of the resin fill system in accordance with another preferred embodiment of the invention;

FIG. 4 is a sectional view of an EDI module including a replaceable membrane element in accordance with a preferred embodiment; and

FIG. 5 is a partial sectional view of an EDI module in accordance with another preferred embodiment of the invention.

### DETAILED DESCRIPTION OF THE INVENTION

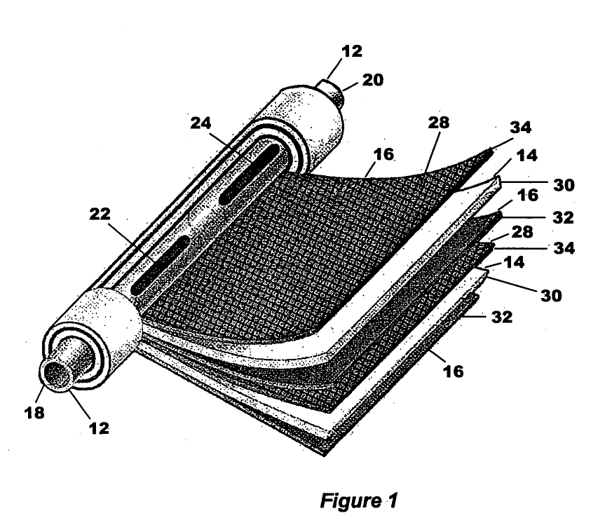

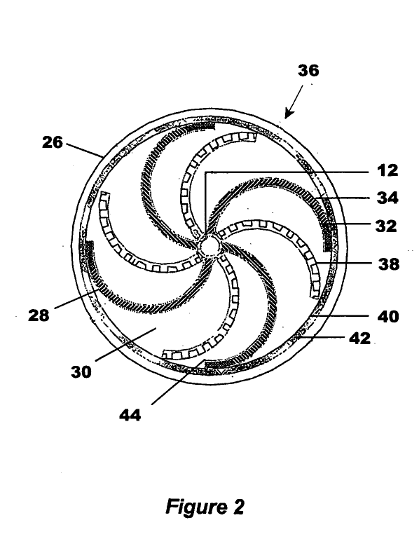

In an exemplary embodiment, the serviceable electrodeionization apparatus includes replaceable membrane element 10. FIG. 1 shows the wound membrane element 10 having a conduit member (e.g. stainless steel central concentrate pipe 12), chambers 14 and membranes 16. The membranes 16 are similar to reverse osmosis membranes used during a pretreatment process before EDI that removes a majority of ions from tapwater, city water, well water or surface water resulting in purified water. As shown in FIG. 1, the membranes 16 and chambers 14 are rolled around the stainless steel concentrate pipe 12 to form a cylindrical element. Adhesives (e.g., glue) are used to seal the membranes 16, chambers 14, and concentrate pipe 12 together to form the spiral wound membrane element 10. As can be seen in FIG. 2, the element 10 is then placed into a housing 26 (e.g. a fiberglass pressure vessel), and the dilute chamber spacers 14 are filled with resin. The unit (membrane element 10 with resin filled spacers 14) is then sealed inside the housing 26.

As can be seen in FIG. 1, the pipe 12 includes a first end port 18, a second end port 20, a first channel port 22 and a second channel port 24. The first and second end ports 18, 20 function as an inlet and an outlet for concentrate to enter and exit the pipe 12. While not being limited to a particular theory, the determination of whether an end port 18, 20 is an inlet or an outlet for the concentrate depends on the direction of concentrate flow into and out of the pipe 12. For purposes of demonstration, in the exemplary embodiment shown in FIG. 1, the first end port 18 is the concentrate inlet and the second end port 20 is the concentrate outlet.

As shown in FIG. 1, the chambers 14 include concentrate chambers 28 and dilute chambers 30. The membranes 16 are cation exchange membranes 32 and anion exchange membranes 34 partially sealed to define concentrate chambers 28 therebetween. That is, one set of membranes 16 (e.g. a cation exchange membrane 32 and an adjacent anion exchange membrane 34) defines a concentrate chamber 28. A dilute chamber 30 is preferably a spacer located adjacent any of the membranes 16 opposite the concentrate chamber 28. Accordingly, layers of wound chambers 14 and membranes 16 preferably cycle in order, for example, as a cation exchange membrane 32, a concentrate chamber 28, an anion exchange membrane 34, a dilute chamber 30, etc. The wound membrane element 10 may include one or more wound sets of membranes 16 and spacers 14, as desired.

As noted above, the pipe 12 include first and second channel ports 22, 24. The first channel port 22 and the second channel port 24 are adapted to communicate concentrate within the concentrate chamber 28. While not being limited to a particular theory, the first channel port 22 distributes the concentrate from the pipe 12 into the concentrate chamber 28. The distributed concentrate cycles within the concentrate chamber 28 and re-enters the pipe 12 at the second spacer port 24 as collected concentrate. The pipe 12 flushes the collected concentrate out of the second end port 20.

Of course if the concentrate flowed in the opposite direction, then the second end port 20 would be the concentrate inlet and the first end port 18 would be the concentrate outlet. In this alternative scenario, the second channel port 24 receives and distributes the concentrate from the second end port 20 into the concentrate chamber 28. Further, the first channel port 22 collects the distributed concentrate that has cycled within the concentrate chamber 28 and flushes the concentrate out of the first end port 18.

While not being limited to a particular theory, the stainless steel central pipe 12 preferably is both a concentrate distributor/collector and a cathode. The pipe 12 is the concentrate distributor/collector since the pipe is adapted to distribute and collect concentrate, for example, as discussed above. The pipe 12 shown in FIG. 1 is stainless steel and is adapted to become an electrode (e.g. a cathode) when attached to an appropriate electric source as readily understood by a skilled artisan. It is also understood that the pipe 12 could alternatively be an anode if attached to an appropriately charged source, if desired. In the exemplary embodiment shown in FIG. 1, the pipe 12 is a central conduit member adapted to be electrically charged as the cathode.

FIG. 2 is a top sectional view of an EDI module 36, including the spiral wound membrane element 10. As shown, the EDI module 36 includes the housing 26 and a titanium or other electrically conductive material layer (e.g. shroud 42) lining the inside of the housing. The shroud 42, when attached to an appropriate electrical current, becomes an anode.

Without being limited to a particular theory, the housing 26 is preferably a fiberglass pressure vessel surrounding a titanium shroud 42. It is understood that the housing 10 can be of any material that enables the housing to hold the membrane element 10. Such materials include conductive materials such as stainless steel with a non-conductive lining. The vessel or housing 26 may or may not contain the shroud 42 as an outer electrode, depending on the interest of the user. The placement of the electrode (e.g. anode, cathode) is not considered critical to the crux of the invention.

Both the housing 26 and the membrane element 10 are replaceable. That is, the membrane element 10 can be removed from the EDI module 36 for servicing, and can be replaced by another membrane element if desired. However, instead of replacing the membrane element 10, a user can empty and refill the dilute chambers 30 with ion exchange resin, for example, and discussed in greater detail below.

Referring to FIG. 2, the EDI module 36 includes the housing 26, shroud 42, central tube 12, anion exchange membrane 34, cation exchange membrane 32, dilute chamber 30 and concentrate chamber 28. Each concentrate chamber 28 is defined by a cation exchange membrane 32 on one side and an anion exchange membrane 34 on an opposite side. The opposing cation exchange membrane 32 and anion exchange membrane 34 have edges that extend beyond the concentrate chamber 28 located therebetween. The edges of both membranes are sealed together to form a membrane bag 44 that keeps concentrate water in the concentrate chamber 28 from leaking out into the dilute chamber 30.

The dilute chamber 30 shown in FIG. 2 includes a dilute support frame 38 that provides spatial and structural support to the membrane element 10. It is understood that the dilute spacer or the dilute support frame 38 is not required in the preferred embodiments since the membranes 16 concentrate chamber 28 and dilute chamber 30 can be sealed by an adhesive, and since the dilute chamber can be emptied and refilled with resin without the dilute spacer and support frame. The membrane element 10 is further sealed by a plastic protecting net 40.

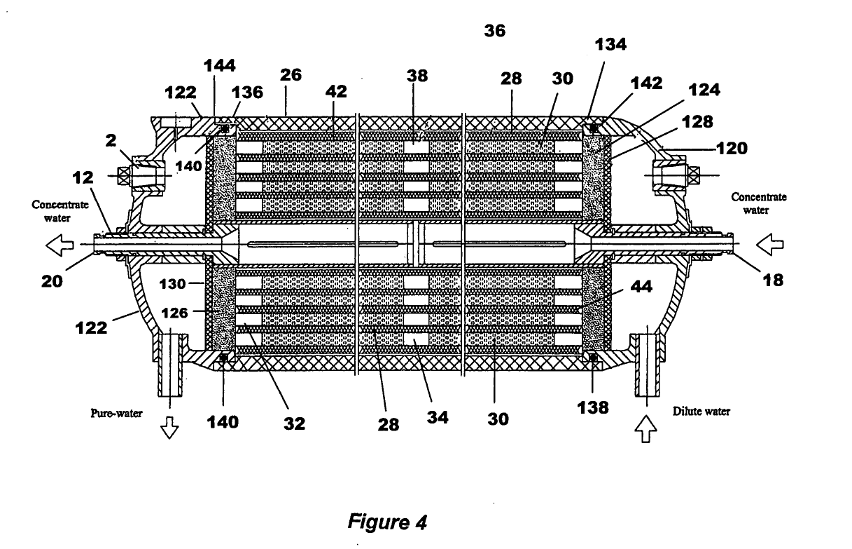

While not being limited to a particular theory, the dilute chambers 30 are preferably filled with ion exchange resin after the membrane element 10 is installed in the housing 26. To this end, the dilute support frame 38 aids in providing stiffness and shape to the membrane element 10 as the membranes 16 and chambers 14 are wound around the central pipe 12 and covered by the plastic protecting net 40. The support frames 38 shown in FIG. 2 do not extend the width of the dilute chamber 30 between the adjacent cation exchange membrane 32 and anion exchange membrane 34 located on opposite sides thereof. In this structural scenario, it is preferred to spatially offset the support frame 38 between adjacent membranes 16 for consistent resin filling and refill after the membrane element 10 is installed. It should be noted that in other exemplary embodiments of the membrane element (e.g. FIG. 4), the support frame 38 does preferably extend the width of the dilute chamber 30.

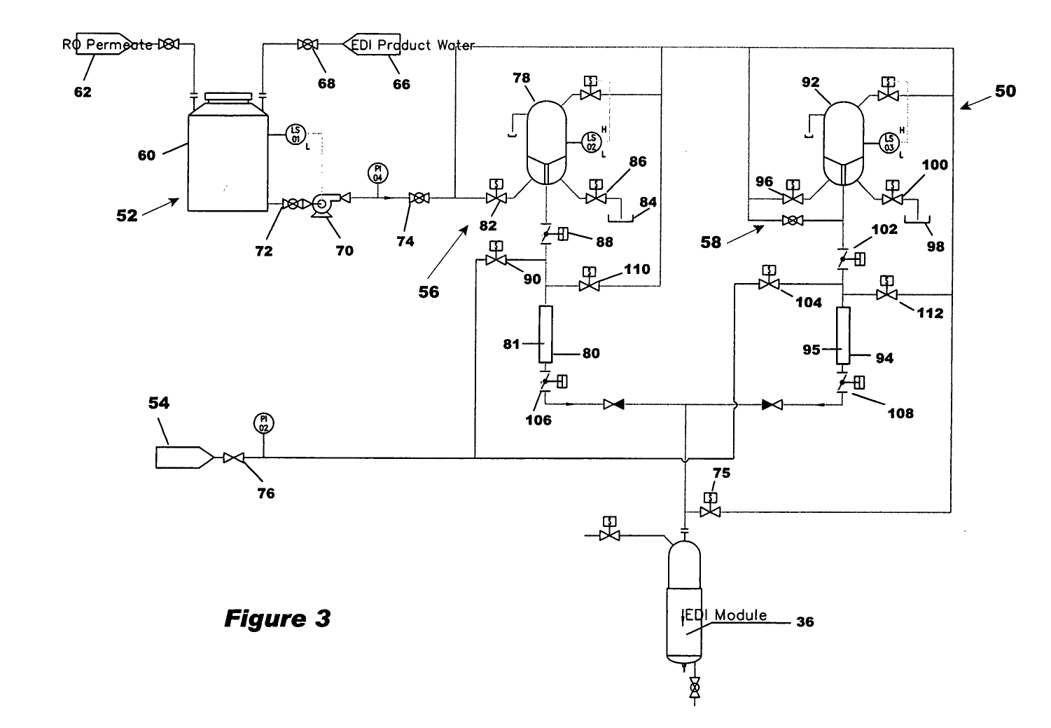

After the spiral wound replaceable membrane element 10 is inserted into the housing, the dilute chamber is filled with resin. The resin filling procedure includes alternate processes of cation resin filling and anion resin filling. FIG. 3 shows an EDI module 36 temporarily coupled to an exemplary filling system 50 used for the resin filling procedure. The filling system 50 includes a water supply 52, an air supply 54, a cation resin station 56 and an anion resin station 58. In a preferred embodiment, the filling system 50 is mobile and transportable to the locations where the EDI modules are used so that the EDI modules do not have to be removed from the field for servicing.

The water supply 52 provides water that can be transferred to the cation resin station 56, the anion resin station 58, and the EDI module 36 as desired. The water supply 52 includes a reverse osmosis tank 60 that stores water received from a reverse osmosis permeate source 62 via ball valve 64, or from an EDI product water source 66 via a ball valve 68. Reverse osmosis permeate water and EDI product water are purified and preferred for use in the filling system 50. However, it is understood that other water may be used as desired or necessary to operate the filling system 50. The water supply 52 also includes a water supply pump 70 that receives water from the reverse osmosis (RO) tank 60 via a ball valve 72, and pumps water via a ball valve 74 to the cation resin station 56, the anion resin station 58 and the EDI module 36. A solenoid valve 75 is located between the water supply 52 and the EDI module 36 to control fluid communication therebetween. In particular, the solenoid valve 75 is positioned between the ball valve 74 and the EDI module 36, and allows or inhibits fluid from the water supply 52 to the EDI module as explained in greater detail below.

Reverse osmosis permeate is the product water which passes through reverse osmosis membranes. Reverse osmosis is typically used as a pretreatment to EDI to remove a majority of ions from water. Generally, city water, well water, tap water or surface water entering directly into an EDI module 36 will cause scaling and/or fouling and damage the EDI module. Therefore, reverse osmosis is used to purify the water before it is again purified by the EDI module 36.

The air supply 54 is pneumatically coupled to the cation resin station 56 and the anion resin station 58 via a solenoid valve 76. The air supply 54 is adapted to transfer compressed air to the stations 56, 58 to help move resin to the EDI module 36, as will be described in greater detail below.

The cation resin station 56 includes a cation resin tank 78 and a cation resin metering tank 80. The cation resin tank 78 stores cation resin and has access to water from both the water supply 52 via a solenoid valve 82 and also from a reservoir 84 via solenoid valve 86. Resin from the cation resin tank 78 is transferred to the cation resin metering tank 80 upon opening diaphragm valve 88 and solenoid valve 90, which introduces compressed air into the cation resin station 56. The cation resin metering tank 80 is a generic tank used to measure the cation resin. Cation resin from the cation resin metering tank 80 is transferred to the EDI module 36 via a diaphragm valve 106. The cation resin metering tank 80 includes a cation filling cup 81 used to measure and transfer resin and water between both the water supply 52 and the cation resin tank 78 to the EDI module 36 as described in greater detail below.

The anion resin station 58 includes an anion resin tank 92 and an anion resin metering tank 94. The anion resin tank 92 stores anion resin and has access to water from both the water supply 52 via solenoid valve 96 and also from a reservoir 98 via solenoid valve 100. Resin from the anion resin tank 92 is transferred to the anion resin metering tank 94 upon opening diaphragm valve 102 and solenoid valve 104, which introduces compressed air into the anion resin station 58. The anion resin metering tank 94 is a generic tank used to measure the anion resin that is transferred to the EDI module 36 via diaphragm valve 108. The anion resin metering tank 94 includes an anion filling cup 95 used to measure and transfer resin and water between both the water supply 52 and the cation resin tank 78 to the EDI module 36 as described in greater detail below.

The preferred method for replacing resin in the EDI module 36 is described below with reference in particular to FIG. 3. It is understood that in order to replace resin in the EDI module 36, old resin in the module must be flushed out to empty the dilute chamber(s) 30. This is accomplished preferably by removing a cover and resin blocking unit (e.g., resin seepage-proof insert, capboard) to free the resin and by positioning the EDI module 36 so that gravity can pull the freed resin from the dilute chamber 30.

For cation resin filling, diaphragm valve 88 and solenoid valve 90 are opened and cation resin flows from the cation resin tank 78 to the cation resin metering tank 80. When the cation resin metering tank 80 is filled by resin to a predetermined mark set as desired by a user, the valves 88, 90 are closed. Typical predetermined marks are set when the cation resin metering tank 80 is completely filled by the cation resin, or when the metering tank 80 is partially filled with an amount of cation resin desired to be inserted into dilute chamber 30 of the EDI module 36 at a time.

Next, solenoid valve 86 is opened to transfer a liquid (e.g., water) from the reservoir 84 into the cation resin metering tank 80 until a specified liquid level is reached in the cation filling cup 81. Continuing with this exemplary method, solenoid valve 75 is opened to transfer liquid (e.g., water) from the water supply 52 into the EDI module 36 until a specified liquid level is reached in the EDI module, and then the solenoid valve 75 is closed. Then the solenoid valve 86 is closed. Next, solenoid valve 110, solenoid valve 90 and diaphragm valve 106 are opened to transfer water from the water supply 52 and air from the air supply 54 into the cation resin system 56 to move the cation resin that is in the cation resin metering tank 80 into the cation filling cup 81. Solenoid valve 110 is then closed, the desired resin is transferred from the cation filling cup 81 into the EDI module 36, and then solenoid valve 90 and diaphragm valve 106 are closed.

Preferably both cation and anion resin are filled into the dilute chamber 30. In the preferred embodiment of this invention, the cation and anion resin are alternately inserted into the dilute chamber 30 for filling the chamber. However, it is understood that both resins could be inserted into the chamber simultaneously or as needed to provide a desired ratio of anion and cation resin in the membrane element 10.

To fill the dilute chamber 30 with anion resin as shown in FIG. 3, diaphragm valve 102 and solenoid valve 104 are opened until the anion resin metering tank 94 is filled by anion resin to a desired level, and then the valves are closed. While not being limited to a particular theory, the desired level is preferably reached when the anion resin completely fills the anion resin metering tank 94. However, it is understood that the desired level is set according to the amount of anion resin that will be transferred into the dilute chamber 30 or some amount of anion resin desired for transferring to the dilute chamber in installments.

Continuing with the exemplary method, solenoid valve 100 is then opened to transfer a liquid (e.g.,water) from a reservoir 98 into the anion resin metering tank 94 until a specified or desired liquid level is reached in the anion filling cup 95, and then the solenoid valve is closed. Then solenoid valve 75 is opened to transfer the liquid (e.g., water) from the water supply 52 into the EDI module 36 until a specified or desired liquid level is reached in the EDI module, and then the solenoid valve 75 is closed. Next, solenoid valves 104 and 112, and diaphragm valve 108 are opened to communicate water from the water supply 52 and air from the air supply 54 into the anion resin system 58 to move the anion resin from the anion resin metering tank 94 into the filling cup. Solenoid valve 112 is then closed. The anion resin from the anion filling cup 95 is emptied into the EDI module 36, and then solenoid valve 104 and diaphragm valve 108 are closed. Preferably, the procedures for cation resin refill and anion resin refill are repeated until the dilute chamber 30 of the EDI module 36 is completely filled with resin.

The valves, motors and other elements shown in FIG. 3 are labeled and disclosed as used in a preferred embodiment. While not being limited to a particular theory, it is generally recognized that the schematic symbols may refer to specific types of valves (e.g., ball valves, solenoid valves, check valves, diaphragm valves). It is understood that various types of valves could be used as alternatives to the disclosed valves, and the schematic symbol of a specific type of valve is by example, and is not intended to limit the type of valve that can be used for the intended purpose of allowing or inhibiting a flow. In other words, a skilled artisan would understand that any valve, motor, pump, etc. that would work for its intended purpose could be used for the disclosed elements without departing from the invention. As such, the specific type of valve, motor, pump, etc. is not critical to the invention. What is important is the function and relationship of the elements.

An exemplary EDI module 36 filled with resin in accordance with the preferred method described above is shown in FIG. 4. As shown, the EDI module 36 includes the housing 26, shroud 42, pipe 12, concentrate chamber 26, dilute chamber 30, dilute support frame 38, cation exchange membrane 32, anion exchange membrane 34, first end port 18 and second end port 20 as described above. The EDI module 36 also includes a first cover 120, a second cover 122, a first resin seepage-proof insert 124, a second resin seepage-proof insert 126, a first clapboard 128, and a second clapboard 130. As can be seen in FIG. 4, the EDI module 36 also includes the dilute support frame 38 arranged in the dilute chamber 30 to provide support for the dilute and to ensure that the dilute chamber maintains its form during resin refill.

While not being limited to a particular theory, the first and second covers 120, 122 are generally dome shaped and enclose the clapboards 128, 130 and resin seepage-proof inserts 124, 126, respectively. The resin seepage-proof inserts 124, 126 block resin from exiting out of the dilute chambers, yet allow water to filter through. The inserts 124, 126 are preferably made from a multiple holed material (e.g. high alkaline polymer with microscopic hollow channels crossed together to make holes of even distribution). Of course, other materials that allow water flow and block resin flow are considered alternatives. Each resin seepage-proof insert 124, 126 is covered and fixed by a respective clapboard 128, 130, preferably are filter plates having multiple holes for allowing liquid through. The clapboards 128, 130 are also known as water distributing boards. Each corresponding resin seepage-proof insert and clapboard are considered in combination as a resin blocking unit and are sealed and covered by a respective cover 120, 122 of the EDI module 36.

Preferably concentrate water located in a concentrate chamber 28 does not seep through the resin seepage-proof inserts 124, 126, since adjacent anion and cation membranes 16 are partially sealed, and in particular are sealed adjacent the resin seepage-proof inserts 124, 126 to form the membrane bag 44 that defines the concentrate chamber 28. An unsealed portion of the membrane bag 44 is attached to the concentrate pipe 12 along the axle direction of the pipe and about the channel ports 22, 24. The attached unsealed portion is adapted to fit around the channel ports 22, 24 to allow concentrate water to flow from the concentrate pipe 12 through the first channel port 22 into the membrane pipe 132 and back through the second channel port 24 into the pipe. As discussed above, the concentrate waters are flushed from the EDI module 36 out of the concentrate pipe 12.

As can be seen in FIG. 4, the covers 120, 122 are coupled to the housing 26 to enclose the membrane element 10. Preferably the covers 120, 122 are coupled to the housing 26 by sliding the covers within interior circumferential walls 134, 136, creating a frictional seal. If desired, the seal may be enhanced by inserting O-rings 138, 140 between the interior circumferential walls 134, 136 of the housing 26 and exterior walls 142, 144 of the covers 120, 122.

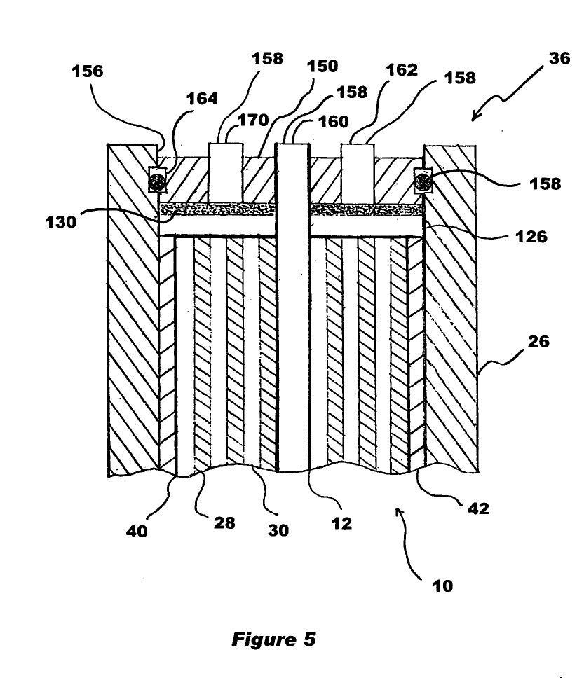

Another exemplary structure for the EDI module 36 is shown in FIG. 5. As shown, the EDI module 36 includes a cover 150 that is generally flat instead of dome shaped. The cover 150 has a matching cover on the opposite side of the housing 26, and is frictionally engaged within an interior wall 156 of the housing to form a frictional seal therebetween. The cover 150 is generally disk shaped and includes an O-ring 158 about its outer circumferential wall 164 that helps form the seal with the interior wall 156 of the housing 26.

The cover 150 also includes apertures 158 that allow fluid communication into the EDI module 36. While not being limited to a particular theory, the apertures 158 are generally arranged substantially parallel to the concentrate pipe 12 and include a concentrate aperture 160, a dilute aperture 162 and a sampling port 170. The concentrate aperture 160 is adapted to communicate with the concentrate pipe 12 of the membrane element 10 and allow concentrate water to enter or exit the pipe. The dilute aperture 162 is adapted to communicate with the dilute chamber 30 and allows dilute water to access the dilute chamber as feed water or to flow from the dilute chamber as product water. The sampling port 170 is used to access the dilute or pure water for sampling or testing as desired. The sampling port 170 is generally plugged or closed to prevent unwanted leakage when access via the port is not desired.

The cover 150 provides a more cost efficient alternative approach than the dome shaped covers 120, 122 shown in FIG. 4. While the cover 150 is shown in contact with the clapboard 130, generally space is present between the two to allow water to flow evenly over and through the clapboard. In fact, the clapboard 130 (or water distribution board) shown in FIG. 5 is not required, with its absence providing additional space between the cover 150 and the resin seepage proof insert 126 for even water flow therebetween. The resin seepage proof insert 126 discussed above is shown sealed between the membrane element 10 and the cover 150 in FIG. 5. The membrane element 10 is shown within the titanium shroud 42, and includes the pipe 12, concentrate chamber 28, dilute chamber 30 and protecting net 40 as discussed above.

It should be apparent from the aforementioned description and attached drawings that the concept of the present invention may be readily applied to a variety of preferred embodiments, including those disclosed herein. Without further elaboration, the foregoing will so fully illustrate the invention that others may, by applying current or future knowledge, readily adapt the same for use under various conditions of service.

What is claimed is:

1. A method for resin refill comprising:
(a) moving a first resin from a first resin tank to a first resin metering tank;
(b) transferring a first liquid to a first filling container;
(c) moving the first resin from the first resin metering tank to the first filling container;
(d) transferring the first resin and the first liquid from the first filling container to an EDI module;
(e) moving a second resin from a second resin tank to a second resin metering tank;
(f) transferring a second liquid to a second filling container;
(g) moving the second resin from the second resin metering tank to the second filling container; and
(h) transferring the second resin and the second liquid from the second filling container to the EDI module.

2. The method of claim 1, before step (a), further comprising flushing an ion resin out of the EDI module.

3. A method for resin refill comprising:
(a) combining a first resin from a first resin tank with a first liquid to form a first resin/liquid compound;
(b) transferring the first resin/liquid compound to a dilute chamber in an EDI module;
(c) combining a second resin from a second resin tank with a second liquid to form a second resin/liquid compound; and
(d) transferring the second resin/liquid compound to a dilute chamber in an EDI module.

4. The method of claim 3, before step (a), further comprising flushing an ion resin out of the EDI module.

5. The method of claim 3, wherein step (a) includes moving the first resin from the first resin tank to a first resin metering tank, transferring the first liquid to a first filling container, and moving the first resin from the first resin metering tank to the first filling container.

6. The method of claim 5, wherein step (c) includes moving the second resin from the second resin tank to a second resin metering tank, transferring the second liquid to a second filling container, and moving the second resin from the first resin metering tank to the second filling container.

7. The method of claim 3, wherein step (a) includes moving the first resin from the first resin tank to a first filling container, and transferring the first liquid to the first filling container.

8. The method of claim 7, wherein step (c) includes moving the second resin from the second resin tank to a second filling container, and transferring the second liquid to the second filling container.

9. The method of claim 3, wherein step (c) includes moving the second resin from the second resin tank to a second resin metering tank, transferring the second liquid to a second filling container, and moving the second resin from the first resin metering tank to the second filling container.

10. The method of claim 3, wherein step (c) includes moving the second resin from the second resin tank to a second resin metering tank, moving the second resin from the second resin metering tank to a second filling container, and transferring the second liquid to the second filling container.

11. The method of claim 3, further comprising repeating steps (a), (b), (c), and (d) until the EDI module is filled to a desired level.

12. The method of claim 3, wherein the first liquid and the second liquid are the same liquid.

13. An EDI module resin refill system, comprising:
a first resin tank for storing a first resin and a second resin tank for storing a second resin;
a first resin metering tank that stores a predetermined amount of the first resin transferred from said first resin tank, said first resin metering tank including a first filling container that stores the predetermined amount of first resin transferred from said first resin metering tank together with a first liquid for delivery of the first resin to the EDI module;
a first valve located between said first resin tank and said first resin metering tank for controlling the transfer of the predetermined amount of first resin to said first resin metering tank;
a second resin metering tank that stores a predetermined amount of the second resin transferred from said second resin tank, said second resin metering tank including a second filling container that stores the predetermined amount of second resin transferred from said second resin metering tank together with a second liquid for delivery of the second resin to the EDI module; and
a second valve located between said second resin tank and said second resin metering tank for controlling the transfer of the predetermined amount of second resin to said second resin metering tank.

14. The system of claim 13, further comprising a third valve located between said first resin metering tank and said first filling container for controlling the transfer of the predetermined amount of first resin to said first filling container, and a fourth valve located between said second resin metering tank and said second filling container for controlling the transfer of the predetermined amount of second resin to said second filling container.

15. A replaceable membrane element of an EDI device, comprising an axially extending conduit acting as a water distributing or gathering member; an anion exchange membrane attached to said axially extending conduit and having a first perimeter edge; a cation exchange membrane attached to said axially extending conduit and having a second perimeter edge; a rolled membrane bag formed by sealing said first perimeter edge with said second perimeter edge, said rolled membrane bag rolled around said axially extending conduit to form a cylindrical element having a concentrate chamber and a dilute chamber defined by said rolled membrane bag; and a protective net surrounding said cylindrical element.
